(19) United States
(12) Patent Application Publication
(10) Pub. No.: US 2016/0175647 A1
(43) Pub. Date: Jun. 23, 2016

(54) EXERCISE ANALYSIS DEVICE, EXERCISE ANALYSIS SYSTEM, EXERCISE ANALYSIS METHOD, DISPLAY DEVICE, AND RECORDING MEDIUM

(71) Applicant: SEIKO EPSON CORPORATION, Tokyo (JP)

(72) Inventor: Kenya KODAIRA, Azumino-shi (JP)

(73) Assignee: SEIKO EPSON CORPORATION, Tokyo (JP)

(21) Appl. No.: 14/963,659

(22) Filed: Dec. 9, 2015

(30) Foreign Application Priority Data
Dec. 22, 2014 (JP) 2014-258535

(51) Int. Cl. A63B 24/00; G01P 15/02; G01P 3/00

(52) U.S. Cl. CPC A63B 24/0003; G01P 3/00; G01P 15/02

(57) ABSTRACT

An exercise analysis device includes: an angle detector that obtains a change in a rotation angle occurring around an axis of a shaft portion of an exercise tool in a swing by using an output of an inertial sensor; and an evaluator that performs at least partial evaluation from start to end of the swing based on the change in the rotation angle.

### BACKGROUND

1. Technical Field

The present invention relates to an exercise analysis device, an exercise analysis system, an exercise analysis method, a display device, and a recording medium.

2. Related Art

In golf swings, there are several checkpoints such as halfway back, top, natural-uncock, and halfway down during a period from address to impact. For golfers to aim at ideal swings, to take good postures at the checkpoints is a shortcut.

In the related art, it is effective to photograph swing motions to check golf swings. For example, JP-A-2012-239627 discloses a technology for measuring a face rotation of a golf club by a behavior measurement device (camera).

In JP-A-2012-239627, however, there is a problem in that a measurement result of the face rotation is used merely to select the number of golf clubs and a swing may not be evaluated simply and objectively.

### SUMMARY

An advantage of some aspects of the invention is that it provides an exercise analysis device, an exercise analysis system, an exercise analysis method, and a program capable of evaluating a swing simply and objectively.

The invention can be implemented as the following forms or application examples.

### Application Example 1

An exercise analysis device according to this application example includes: an angle detector that obtains a change in a rotation angle occurring around an axis of a shaft portion of an exercise tool in a swing by using an output of an inertial sensor; and an evaluator that performs at least partial evaluation from start to end of the swing based on the change in the rotation angle. Accordingly, the exercise analysis device according to this application example can evaluate at least some of swings of a user simply and objectively.

### Application Example 2

In the exercise analysis device according to the application example, the evaluator may evaluate take-back based on the change in the rotation angle during a period from the start of the swing to halfway-back. Accordingly, the exercise analysis device according to this application example can evaluate the take-back of the user particularly in detail.

### Application Example 3

In the exercise analysis device according to the application example, the evaluator may evaluate a downswing based on the change in the rotation angle during a period from top to halfway-down. Accordingly, the exercise analysis device according to this application example can evaluate the downswing of the user particularly in detail.

### Application Example 4

In the exercise analysis device according to the application example, the evaluator may evaluate a posture of a user handling the exercise tool based on a difference between the rotation angle at the start of the swing and the rotation angle at impact. Accordingly, for example, the exercise analysis device according to this application example can evaluate the posture of the impact and the address of the user particularly in detail.

### Application Example 5

An exercise analysis system according to this application example includes: the exercise analysis device according to the application example; and an inertial sensor. Accordingly, the exercise analysis system according to this application example can evaluate the swing of the user simply and objectively.

### Application Example 6

An exercise analysis method according to this application example includes: obtaining a change in a rotation angle occurring around an axis of a shaft portion of an exercise tool in a swing by using an output of an inertial sensor; and performing at least partial evaluation from start to end of the swing based on the change in the rotation angle. Accordingly, the exercise analysis method according to this application example can evaluate the swing of the user simply and objectively.

### Application Example 7

In the exercise analysis method according to the application example, in evaluating, take-back may be evaluated based on the change in the rotation angle during a period from the start of the swing to halfway-back.

### Application Example 8

In the exercise analysis method according to the application example, in evaluating, a downswing may be evaluated based on the change in the rotation angle during a period from top to halfway-down.

### Application Example 9

In the exercise analysis method according to the application example, in evaluating, a posture of a user handling the exercise tool is evaluated based on a difference between the rotation angle at the start of the swing and the rotation angle at impact.

### Application Example 10

A display device according to this application example displays, using an output of an inertial sensor, a change in a rotation angle occurring around an axis of a shaft portion of an exercise tool in a swing and at least partial evaluation from start to end of the swing based on the change in the rotation angle.

### Application Example 11

A recording medium according to this application example records an exercise analysis program causing a computer to perform: an angle detection procedure of obtaining a change in a rotation angle occurring around an axis of a shaft portion of an exercise tool in a swing by using an output of an inertial sensor; and an evaluation procedure of performing at least partial evaluation from start to end of the swing based on the change in the rotation angle. Accordingly, the recording medium according to this application example can evaluate the swing of the user simply and objectively.

### BRIEF DESCRIPTION OF THE DRAWINGS

The invention will be described with reference to the accompanying drawings, wherein like numbers reference like elements.

FIG. 1 is a diagram illustrating the overview of a swing analysis system as an example of an exercise analysis system according to an embodiment.

FIG. 2 is a diagram illustrating an example of a position and a direction in which a sensor unit is mounted.

FIG. 3 is a diagram illustrating a procedure of a motion performed by a user according to the embodiment.

FIG. 4 is a diagram illustrating an example of the configuration of a swing analysis system according to the embodiment.

FIG. 5 is a diagram illustrating a relation between a golf club and a global coordinate system Σ_{XYZ} in address.

FIG. 6 is a flowchart illustrating an example of the procedure of a swing analysis process according to the embodiment.

FIG. 7 is a flowchart illustrating an example of the procedure of a first motion detection process.

FIG. 8A is a diagram illustrating a graph of a triaxial angular velocity at the time of a swing.

FIG. 8B is a diagram illustrating a graph of a composite value of the triaxial angular velocity.

FIG. 8C is a diagram illustrating a graph of a differential value of the composite value of the triaxial angular velocity.

FIG. 9 is a flowchart illustrating an example of the procedure of a second motion detection process.

FIG. 10 is a flowchart illustrating an example of the procedure of a swing evaluation process according to the embodiment.

FIG. 11 is a diagram illustrating a temporal change curve of a shaft rotation angle θ (a case of a golf beginner).

FIG. 12 is a diagram illustrating a temporal change curve of the shaft rotation angle θ (a case of an advanced golfer).

FIG. 13 is a diagram illustrating an evaluation result display process (a case of a golf beginner).

FIG. 14 is a diagram illustrating an evaluation result display process (a case of an advanced golfer).

### DESCRIPTION OF EXEMPLARY EMBODIMENTS

Hereinafter, preferred embodiments of the invention will be described in detail with reference to the drawings. Embodiments to be described below do not inappropriately limit content of the invention described in the appended claims. All of the constituent elements to be described below may not be necessarily requisite constituent elements.

Hereinafter, a swing analysis system that analyzes a golf swing will be described as an example of an exercise analysis system.

### 1. Swing Analysis System

### 1-1. Overview of Swing Analysis System

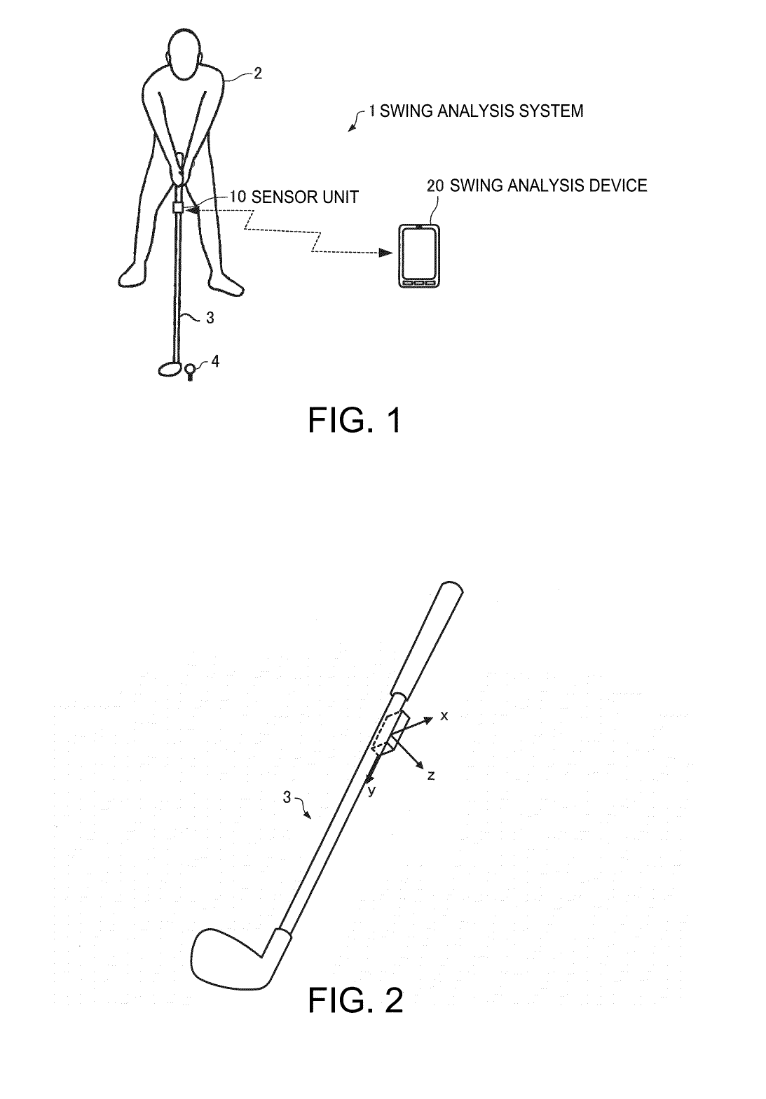

FIG. 1 is a diagram for describing the overview of the swing analysis system according to an embodiment. A swing analysis system 1 according to the embodiment is configured to include a sensor unit 10 (which is an example of an inertial sensor) and a swing analysis device 20 (which is an example of an exercise analysis device).

The sensor unit 10 can measure acceleration generated in each axis direction of three axes and an angular velocity generated around each axis of the three axes and is mounted on a golf club 3 (which is an example of an exercise tool).

In the embodiment, as illustrated in FIG. 2, the sensor unit 10 is fitted on a part of the shaft of the golf club 3 when one axis among three detection axes (the x axis, the y axis, and the z axis), for example, the y axis, conforms with the major axis direction of the shaft. Preferably, the sensor unit 10 is fitted at a position close to a grip in which a shock at the time of hitting is rarely delivered and a centrifugal force is not applied at the time of swing. The shaft is a portion of the grip excluding the head of the golf club 3 and also includes the grip.

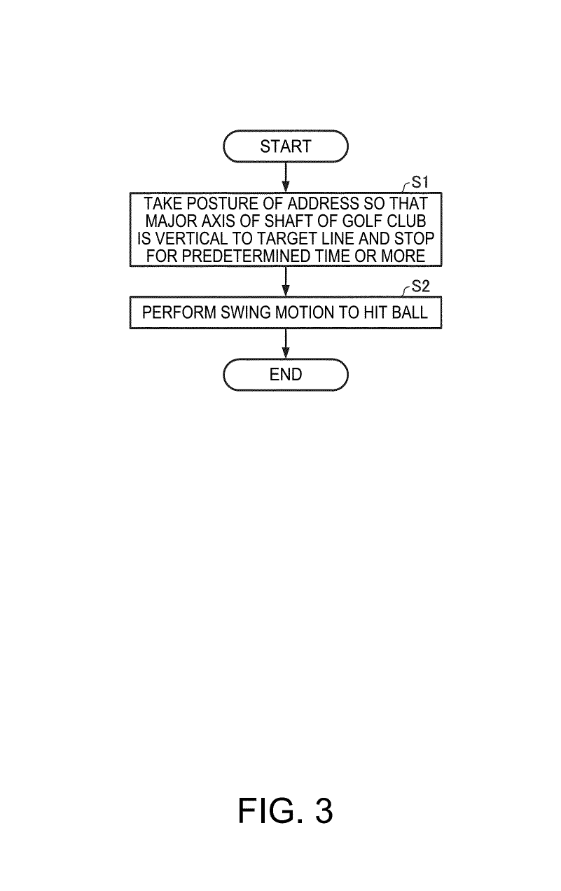

A user 2 performs a swing motion of hitting a golf ball 4 in a pre-decided procedure. FIG. 3 is a diagram illustrating the procedure of a motion performed by the user 2. As illustrated in FIG. 3, the user 2 first holds the golf club 3, takes a posture of address so that the major axis of the shaft of the golf club 3 is vertical to a target line (target direction of hitting), and stops for a predetermined time or more (for example, 1 second or more) (S1). Next, the user 2 performs a swing motion to hit the golf ball 4 (S2).

While the user 2 performs the motion to hit the golf ball 4 in the procedure illustrated in FIG. 3, the sensor unit measures triaxial acceleration and triaxial angular velocity at a predetermined period (for example, 1 ms) and sequentially transmits the measurement data to the swing analysis device 20. The sensor unit 10 may immediately transmit the measurement data, or may store the measurement data in an internal memory and transmit the measurement data at a predetermined timing such as a timing after the end of a swing motion of the user 2. Communication between the sensor unit 10 and the swing analysis device 20 may be wireless communication or wired communication. Alternatively, the sensor unit 10 may store the measurement data in a recording medium such as a memory card which can be detachably mounted and the swing analysis device 20 may read the measurement data from the recording medium.

The swing analysis device 20 according to the embodiment evaluates whether a swing of user is good or bad using data measured by the sensor unit 10. Then, the swing analysis device 20 displays an evaluating result on a displayer (display). The swing analysis device 20 may be, for example, a portable device such as a smartphone or a personal computer (PC).

### 1-2. Configuration of Swing Analysis System

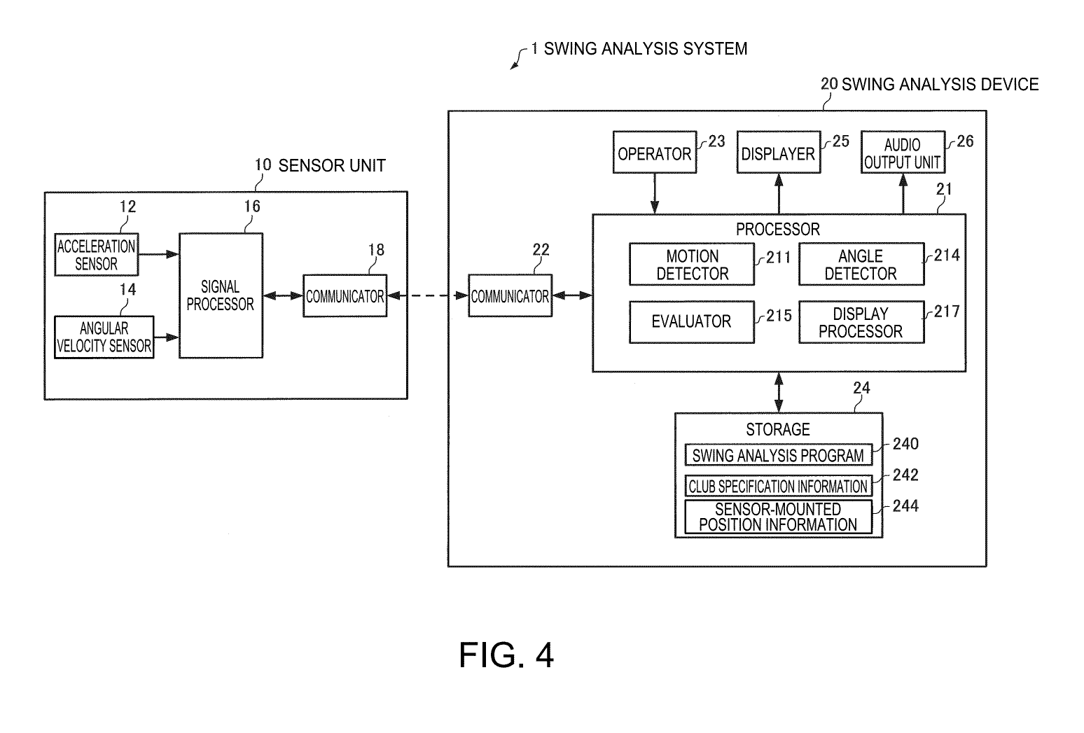

FIG. 4 is a diagram illustrating an example of the configuration of the swing analysis system 1 (examples of the configurations of the sensor unit 10 and the swing analysis device 20) according to the embodiment. As illustrated in FIG. 4, in the embodiment, the sensor unit 10 includes an acceleration sensor 12, an angular velocity sensor 14, a signal processor 16, and a communicator 18.

The acceleration sensor 12 measures acceleration generated in each of mutually intersecting (ideally, orthogonal) triaxial directions and outputs digital signals (acceleration data) according to the sizes and directions of the measured triaxial accelerations.

The angular velocity sensor 14 measures an angular velocity generated around each axis of mutually intersecting (ideally, orthogonal) triaxial directions and outputs digital signals (angular velocity data) according to the sizes and directions of the measured triaxial angular velocities.

The signal processor 16 receives the acceleration data and the angular velocity data from the acceleration sensor 12 and the angular velocity sensor 14, appends time information, and stores the acceleration data and the angular velocity data in a storage (not illustrated). The signal processor 16 generates packet data in conformity to a communication format by appending time information to the stored measurement data (the acceleration data and the angular velocity data) and outputs the packet data to the communicator 18.

The acceleration sensor 12 and the angular velocity sensor 14 are ideally fitted in the sensor unit 10 so that the three axes of each sensor match the three axes (the x axis, the y axis, and the z axis) of the xyz rectangular coordinate system (sensor coordinate system Σ_{xyz}) defined for the sensor unit 10, but errors of the fitting angles actually occur. Accordingly, the signal processor 16 performs a process of converting the acceleration data and the angular velocity data into data of the xyz rectangular coordinate system (sensor coordinate system Σ_{xyz}) using correction parameters calculated in advance according to the errors of the fitting angles.

The signal processor 16 may perform a temperature correction process on the acceleration sensor 12 and the angular velocity sensor 14. Alternatively, a temperature correction function may be embedded in the acceleration sensor 12 and the angular velocity sensor 14.

The acceleration sensor 12 and the angular velocity sensor 14 may output analog signals. In this case, the signal processor 16 may perform A/D conversion on each of an output signal of the acceleration sensor 12 and an output signal of the angular velocity sensor 14, generate measurement data (acceleration data and angular velocity data), and generate packet data for communication using the measurement data.

The communicator 18 performs, for example, a process of transmitting the packet data received from the signal processor 16 to the swing analysis device 20 or a process of receiving control commands from the swing analysis device 20 and transmitting the control commands to the signal processor 16. The signal processor 16 performs various processes according to the control commands.

The swing analysis device 20 includes a processor 21, a communicator 22, an operator 23, a storage 24, a displayer 25, and an audio output unit 26.

The communicator 22 performs, for example, a process of receiving the packet data transmitted from the sensor unit 10 and transmitting the packet data to the processor 21 or a process of transmitting a control command from the processor 21 to the sensor unit 10.

The operator 23 performs a process of acquiring operation data from the user 2 and transmitting the operation data to the processor 21. The operator 23 may be, for example, a touch panel type display, a button, a key, or a microphone.

The storage 24 is configured as, for example, any of various IC memories such as a read-only memory (ROM), a flash ROM, and a random access memory (RAM) or a recording medium such as a hard disk or a memory card.

The storage 24 stores, for example, programs used for the processor 21 to perform various calculation processes or control processes, or various program or data used for the processor 21 to realize application functions. In particular, in the embodiment, the storage 24 stores a swing analysis program 240 which is read by the processor 21 to perform an analysis process for a swing exercise. The swing analysis program 240 may be stored in advance in a nonvolatile recording medium. Alternatively, the swing analysis program 240 may be received from a server via a network by the processor 21 and may be stored in the storage 24.

In the embodiment, the storage 24 stores club specification information 242 indicating the specification of the golf club 3 and sensor-mounted position information 244. For example, the user 2 operates the operator 23 to input a model number of the golf club 3 (or select the model number from a model number list) to be used and set specification information regarding the input model number as the specification information 242 among pieces of specification information for each model number (for example, information regarding the length of a shaft, the position of center of gravity, a lie angle, a face angle, a loft angle, and the like) stored in advance in the storage 24. Alternatively, by mounting the sensor unit 10 at a decided predetermined position (for example, a distance of 20 cm from the grip), information regarding the predetermined position may be stored in advance as the sensor-mounted position information 244.

The storage 24 is used as a work area of the processor 21 and temporarily stores, for example, data input from the operator 23 and calculation results performed according to various programs by the processor 21. The storage 24 may store data necessarily stored for a long time among the data generated through the processes of the processor 21.

The displayer 25 displays a processing result of the processor 21 as text, a graph, a table, animations, or another image. The displayer 25 may be, for example, a CRT, an LCD, a touch panel type display, or a head-mounted display (HMD). The functions of the operator 23 and the displayer 25 may be realized by one touch panel type display.

The audio output unit 26 outputs a processing result of the processor 21 as audio such as a voice or a buzzer sound. The audio output unit 26 may be, for example, a speaker or a buzzer.

The processor 21 performs a process of transmitting a control command to the sensor unit 10, various calculation processes on data received from the sensor unit 10 via the communicator 22, and other various control processes according to various programs. In particular, in the embodiment, the processor 21 performs the swing analysis program 240 to function as a motion detector 211, a angle detector 214, an evaluator 215, and a display processor 217 by executing the swing analysis program 240.

For example, the processor 21 performs operations of receiving the packet data received from the sensor unit 10 by the communicator 22, acquiring time information and measurement data from the received packet data, and storing the time information and the measurement data in the storage 24 in association therewith.

The processor 21 performs, for example, a process of detecting a timing (measurement time of the measurement data) of each motion in a swing of the user 2 using the measurement data.

The processor 21 performs a process of generating time-series data indicating a change in the posture of the sensor unit 10 by applying the angular velocity data included in the measurement data, for example, to a predetermined calculation formula (or the change in the posture is expressed by, for example, rotation angles (a roll angle, a pitch angle, and a yaw angle) of each axis direction, quaternion, a rotation matrix, or the like).

The processor 21 performs a process of generating time-series data indicating a change in the position of the sensor unit 10 by performing, for example, time integration on the acceleration data included in the measurement data (and the change in the position can be expressed by, for example, a speed (speed vector) in each axis direction or the like).

Here, the processor 21 according to the embodiment performs, for example, the following steps (1) to (4) to measure the posture of the shaft at each time point, using the time of the stop of the user 2 (measurement time t₀ of the address) as a criterion.

(1) The processor 21 performs bias correction on the measurement data in the swing by calculating an offset amount included in the measurement data using the measurement data (acceleration data and angular velocity data) at time t₀ and subtracting the offset amount from the measurement data in the swing.

(2) The processor 21 decides the XYZ rectangular coordinate system (global coordinate system Σ_{XYZ}) to be fixed to the ground based on the acceleration data (that is, data indicating the gravity acceleration direction) at time t₀, the club specification information 242, and the sensor-mounted position information 244.

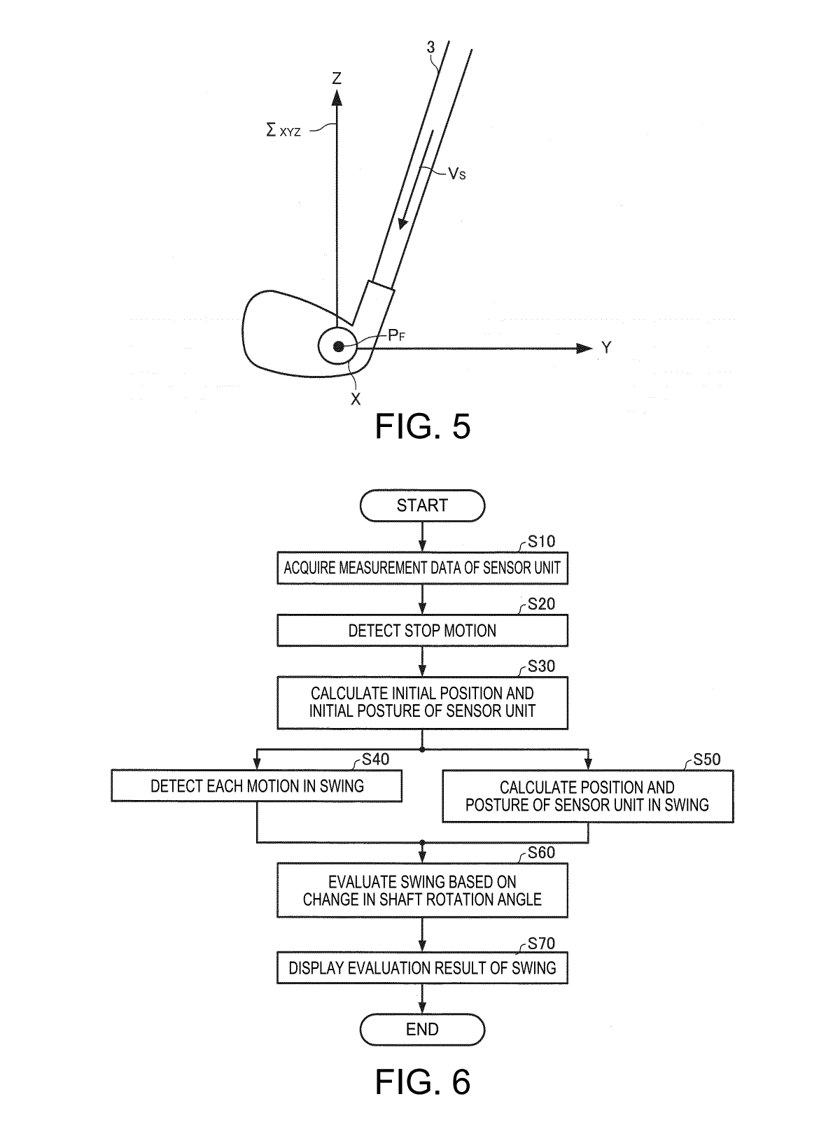

For example, the origin of the global coordinate system Σ_{XYZ} is set to the position of the head at time t₀, as illustrated in FIG. 5, the Z axis of the global coordinate system Σ_{XYZ} is set in the vertical upward direction (that is, the opposite direction to the gravity acceleration direction), and the X axis of the global coordinate system Σ_{XYZ} is set in the same direction as the x axis of the sensor coordinate system Σ_{xyz} at time to. Accordingly, in this case, the X axis of the global coordinate system Σ_{XYZ} can be regarded as a target line.

(3) The processor 21 decides a shaft vector V_{S} indicating the posture of the golf club 3. Any method of selecting the shaft vector V_{S} can be used. In the embodiment, as illustrated in FIG. 5, a unit vector oriented in the major axis direction of the shaft of the golf club 3 is used as the shaft vector V_{S}.

(4) The processor 21 sets the shaft vector V_{S} at time t₀ in the global coordinate system Σ_{XYZ} as an initial shaft vector V_{S} (t=t₀) and calculates a shaft vector V_{S} (t) of each time in the global coordinate system Σ_{XYZ} based on the initial shaft vector V_{S} (t=t₀) and the time-series data (after the bias correction) indicating the change in the posture of the sensor unit 10.

Here, the bias correction of the measurement data has been performed by the processor 21, but may be performed by the signal processor 16 of the sensor unit 10 or the bias correction function may be embedded in the acceleration sensor 12 and the angular velocity sensor 14.

The processor 21 performs a process of reading/writing various programs or various kinds of data from/on the storage 24. The processor 21 performs not only a process of storing time information and the measurement data received from the communicator 22 in the storage 24 in association therewith but also a process of storing various kinds of calculated information or the like in the storage 24.

The processor 21 performs a process of displaying various images (images, text, signs, and the like corresponding to information such as exercise analysis information (evaluation result) generated by the processor 21) on the displayer 25. For example, the display processor 217 causes the displayer 25 to display the images, text, or the like corresponding to the exercise analysis information (evaluation result) generated by the processor 21 after the end of the swing exercise of the user 2, automatically, or according to an input operation of the user 2. Alternatively, a displayer may be provided in the sensor unit 10, and the display processor 217 may transmit image data to the sensor unit 10 via the communicator 22 and cause the displayer of the sensor unit 10 to display various images, text, or the like.

The processor 21 performs a process of causing the audio output unit 26 to output various kinds of audio (including a voice and a buzzer sound). For example, the processor 21 may read various kinds of information stored in the storage 24 and output audio or a voice for analysis of the swing exercise to the audio output unit 26 after the end of the swing exercise of the user 2, automatically, or at the time of performing a predetermined input operation. Alternatively, an audio output unit may be provided in the sensor unit 10, and the processor 21 may transmit various kinds of audio data or voice data to the sensor unit 10 via the communicator 22 and cause the audio output unit of the sensor unit 10 to output various kinds of audio or voices.

A vibration mechanism may be provided in the swing analysis device 20 or the sensor unit 10 and the vibration mechanism may also convert various kinds of information into vibration information and suggest the vibration information to the user 2.

### 1-3. Process of Swing Analysis Device

### Swing Analysis Process

FIG. 6 is a flowchart illustrating the procedure of the swing analysis process for a swing exercise performed by the processor 21 of the swing analysis device 20 according to the embodiment. The processor 21 of the swing analysis device (which is an example of a computer) executes the swing analysis program 240 stored in the storage 24 to perform the swing analysis process of a swing exercise in the procedure of the flowchart of FIG. 6. Hereinafter, the flowchart of FIG. 6 will be described.

First, the processor 21 acquires the measurement data of the sensor unit 10 (S10). In step S10, the processor 21 may perform processes subsequent to step S20 in real time when the processor 21 acquires the first measurement data in a swing (also including a stop motion) of the user 2 or may perform the processes subsequent to step S20 after the processor 21 acquires some or all of a series of measurement data in the swing exercise of the user 2 from the sensor unit 10.

Next, the processor 21 detects a stop motion (address motion) (the motion of step S1 of FIG. 3) of the user 2 using the measurement data acquired from the sensor unit 10 (S20). When the processor 21 performs the process in real time and detects the stop motion (address motion), for example, the processor 21 may output a predetermined image or audio, or an LED may be provided in the sensor unit 10 and the LED may be turned on or off. Then, the user 2 is notified of detection of a stop state, and then the user 2 may start a swing after the user 2 confirms the notification.

Next, the processor 21 calculates the initial position and the initial posture of the sensor unit 10 using the measurement data (the measurement data in the stop motion (address motion) of the user 2) acquired from the sensor unit 10, the club specification information 242, the sensor-mounted position information 244, and the like (S30).

Next, the processor 21 detects the motions (specifically, swing start, halfway-back, top, halfway-down, and impact) of the swing using the measurement data acquired from the sensor unit 10 (S40). A procedure example of the motion detection process will be described below.

The processor 21 calculates the position and the posture of the sensor unit 10 in the swing in parallel to, before, or after the process of step S40 using the measurement data acquired from the sensor unit 10 (S50).

Next, the processor 21 evaluates the swing of the user 2 based on the measurement time of each motion detected in step S40 and the shaft rotation angle (S60). An example of the procedure of a swing evaluation process will be described below.

Next, the processor 21 generates image data indicating the evaluation result of the swing in step S60 and causes the displayer 25 to display the image data (S70), and then the process ends. An example of the procedure of the display process will be described below.

In the flowchart of FIG. 6, the sequence of the steps may be appropriately changed within a possible range.

### First Motion Detection Process

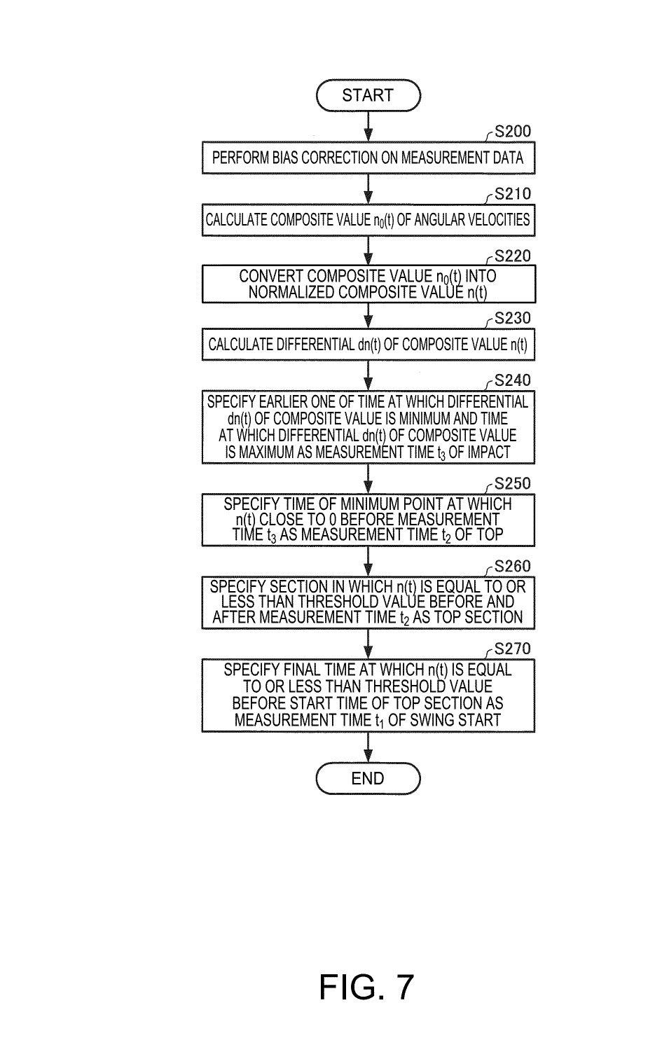

FIG. 7 is a flowchart illustrating an example of the procedure of a first motion detection process (a part of the process of step S40 in FIG. 6). A detection target of the first motion detection process is swing start, top, and impact. The first motion detection process corresponds to an operation of the processor 21 serving as the motion detector 211. Hereinafter, the flowchart of FIG. 7 will be described.

First, the processor 21 performs bias correction on the measurement data (the acceleration data and the angular velocity data) stored in the storage 24 (S200).

Next, the processor 21 calculates the value of a composite value n₀(t) of the angular velocities at each time t using the angular velocity data (the angular velocity data at each time t) subjected to the bias correction in step S200 (S210). For example, when the angular velocity data at time t are x(t), y(t), and z(t), the composite value n₀(t) of the angular velocities is calculated according to formula (1) below.

n₀(t)=\sqrt{x(t)²+y(t)²+z(t)²} (1)

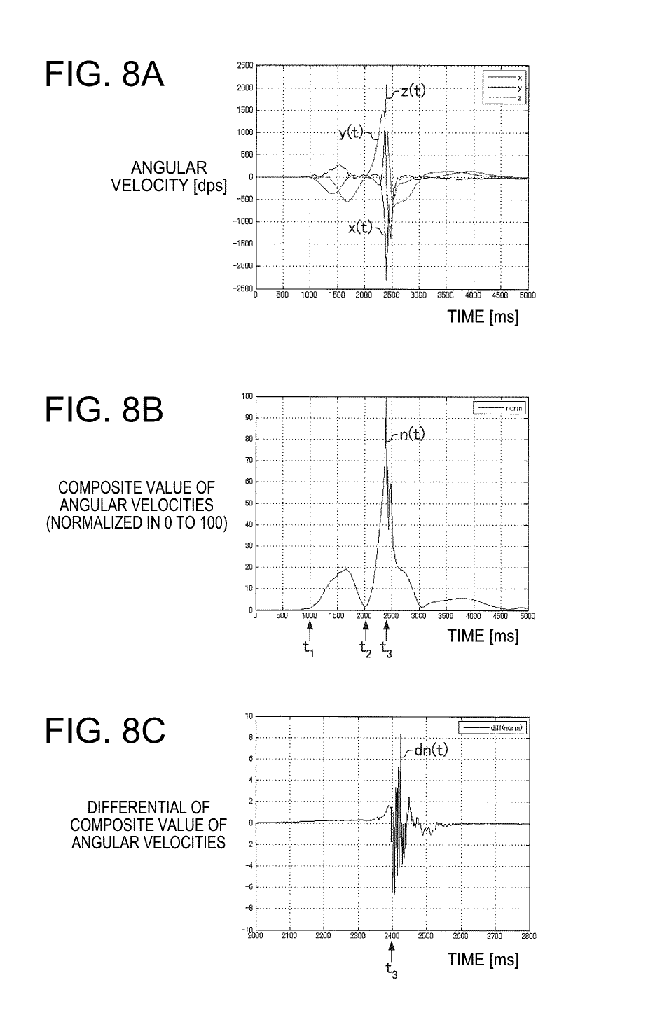

Examples of the triaxial angular velocity data x(t), y(t), and z(t) when the user 2 performs a swing and hits the golf ball 4 are illustrated in FIG. 8A. In FIG. 8A, the horizontal axis represents a time (msec) and the vertical axis represents an angular velocity (dps).

Next, the processor 21 converts the composite value n₀(t) of the angular velocities at each time t into a composite value n(t) normalized (subject to scale conversion) in a predetermined range (S220). For example, when max(n₀) is the maximum value of the composite value of the angular velocity during an acquisition period of the measurement data, the composite value n₀(t) of the angular velocities is converted into the composite value n(t) normalized in a range of 0 to 100 according to formula (2) below.

$$n ( t ) = \frac{100 \times {n}_{0} ( t )}{max ( {n}_{0} )} \qquad ( 2 )$$

FIG. 8B is a diagram illustrating a graph of the composite value n(t) normalized in 0 to 100 according to formula (2) after the composite value n₀(t) of triaxial angular velocities is calculated from the triaxial angular velocity data x(t), y(t), and z(t) in FIG. 8A according to formula (1). In FIG. 8B, the horizontal axis represents a time (msec) and the vertical axis represents a composite value of the angular velocities.

Next, the processor 21 calculates a differential dn(t) of the composite value n(t) after the normalization at each time t (S230). For example, when Δt is a measurement period of the triaxial angular velocity data, the differential (difference) dn(t) of the composite value of the angular velocities at time t is calculated according to formula (3) below.

dn(t)=n(t)−n(t−Δt) (3)

FIG. 8C is a diagram illustrating a graph by calculating the differential dn(t) from the composite value n(t) of the triaxial angular velocities in FIG. 8B according to formula (3). In FIG. 8C, the horizontal axis represents a time (msec) and the vertical axis represents a differential value of the composite value of the triaxial angular velocities. In FIGS. 8A and 8B, the horizontal axis is displayed from 0 seconds to 5 seconds. In FIG. 8C, however, the horizontal axis is displayed from 2 seconds to 2.8 seconds so that a change in the differential value before and after impact can be known.

Next, the processor 21 specifies, as measurement time t₃ of the impact, the earlier one of the time at which the value of the differential dn(t) of the composite value is the minimum and the time at which the value of the differential dn(t) of the composite value is the maximum (S240) (see FIG. 8C). In a normal golf swing, a swing speed is considered to be the maximum at the moment of impact. Since the value of the composite value of the angular velocities is considered to be also changed according to a swing speed, a timing at which the differential value of the composite value of the angular velocities during a series of swing motions is the maximum or the minimum (that is, a timing at which the differential value of the composite value of the angular velocities is the positive maximum value or the negative minimum value) can be captured as a timing of the impact. Since the golf club 3 is vibrated due to the impact, the timing at which the differential value of the composite value of the angular velocities is the maximum is considered to be occurred in pairs with the timing at which the differential value of the composite value of the angular velocities is the minimum. The earlier timing between the timings is considered to be the moment of the impact.

Next, the processor 21 specifies the time of a minimum point at which the composite value n(t) is close to 0 before measurement time t₃ of the impact as measurement time t₂ of the top (S250) (see FIG. 8B). In a normal golf swing, it is considered that the motion temporarily stops at the top after the swing starts, and then the swing speed gradually increases and reaches the impact. Accordingly, a timing at which the composite value of the angular velocities before the timing of the impact is close to 0 and is the minimum can be captured as a timing of the top.

Next, the processor 21 specifies a section in which the composite value n(t) of the angular velocities is equal to or less than a predetermined threshold value before or after measurement time t₂ of the top as a top section (S260). In a normal golf swing, the motion temporarily stops at the top. Therefore, the swing speed is considered to be small before or after the top. Accordingly, a section in which the composite value of the angular velocities is continuously equal to or less than the threshold value, including the timing of the top, can be captured as the top section.

Next, the processor 21 specifies the final time at which the composite value n(t) is equal to or less than a predetermined threshold value before the start time of the top section as measurement time t₁ of the swing start (S270) (see FIG. 8B), and then the process ends. In a normal golf swing, it is difficult to consider that a swing motion starts from a stop state and the swing motion stops until the top. Accordingly, a final timing at which the composite value of the angular velocities is equal to or less than the predetermined threshold value before the timing of the top can be captured as a start timing of a swing motion. A time of the minimum point at which the composite value n(t) is close to 0 before measurement time t₂ of the top may be specified as the measurement time of the swing start.

In the flowchart of FIG. 7, the sequence of the steps can be appropriately changed within a possible range. In the flowchart of FIG. 7, the processor 21 specifies the impact and the like using the triaxial angular velocity data, but can also specify the impact and the like similarly using the triaxial acceleration data.

### Second Motion Detection Process

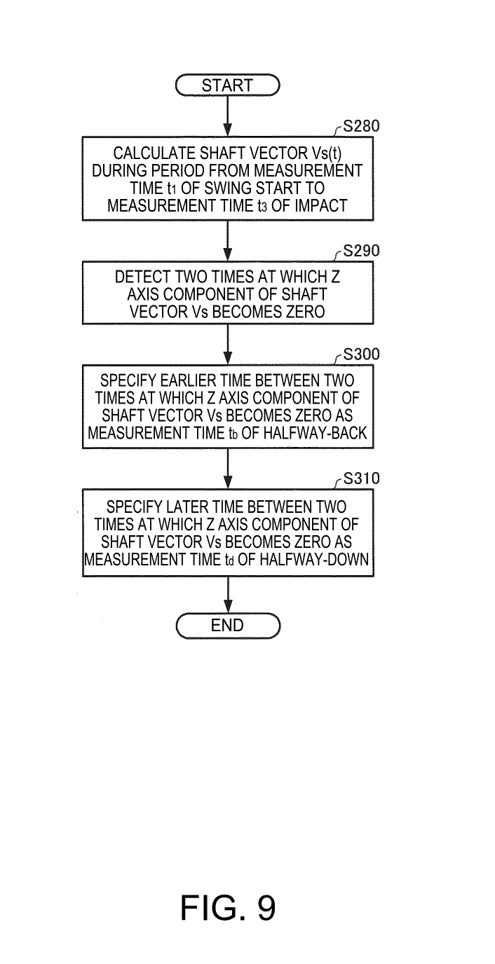

FIG. 9 is a flowchart illustrating an example of the procedure of a second motion detection process (a part of the process of step S40 in FIG. 6). A detection target of the second motion detection process is halfway-back and halfway-down. The second motion detection process corresponds to an operation of the processor 21 serving as the motion detector 211. Hereinafter, the flowchart of FIG. 9 will be described.

First, the processor 21 calculates a shaft vector V_{S}(t) at each time t during a predetermined time (time t₁ to time t₃) from measurement time t₁ of swing start to measurement time t₃ of impact (S280).

Next, the processor 21 detects two times at which the Z axis component of the shaft vector V_{S}(t) is zero during the predetermined time (time t₁ to time t₃) with reference to the Z axis component of the shaft vector V_{S}(t) at each time t (S290).

Next, the processor 21 specifies the earlier time of the two times as measurement time t_{b} of the halfway-back (S300).

The processor 21 specifies the later time of the two times as measurement time t_{d} of the halfway-down (S310) and ends the process.

The “halfway-back” mentioned here refers to a time point at which the shaft of the golf club 3 first becomes horizontal (parallel to the XY plane) after the swing start. The “halfway-down” mentioned here refers to a time point at which the shaft of the golf club 3 subsequently becomes horizontal after the halfway-back.

Accordingly, here, the time at which the Z axis component of the shaft vector V_{S}(t) first becomes zero is regarded as measurement time t_{b} of the halfway-back and the time at which the Z axis component subsequently becomes zero is regarded to as measurement time t_{d} of the halfway-down.

In the flowchart of FIG. 9, only the Z axis component of the shaft vector V_{S} (t) is used. Therefore, the calculation of the X axis component and the Y axis component of the shaft vector V_{S}(t) in step S280 can be omitted.

In the flowchart of FIG. 9, the Z axis component of the shaft vector V_{S} (t) is used to detect the time at which the shaft becomes horizontal. However, other indexes such as the components of some of the quaternions indicating the posture of the shaft may be used.

In the flowchart of FIG. 9, the sequence of the steps may be appropriately changed within a possible range.

### Swing Evaluation Process

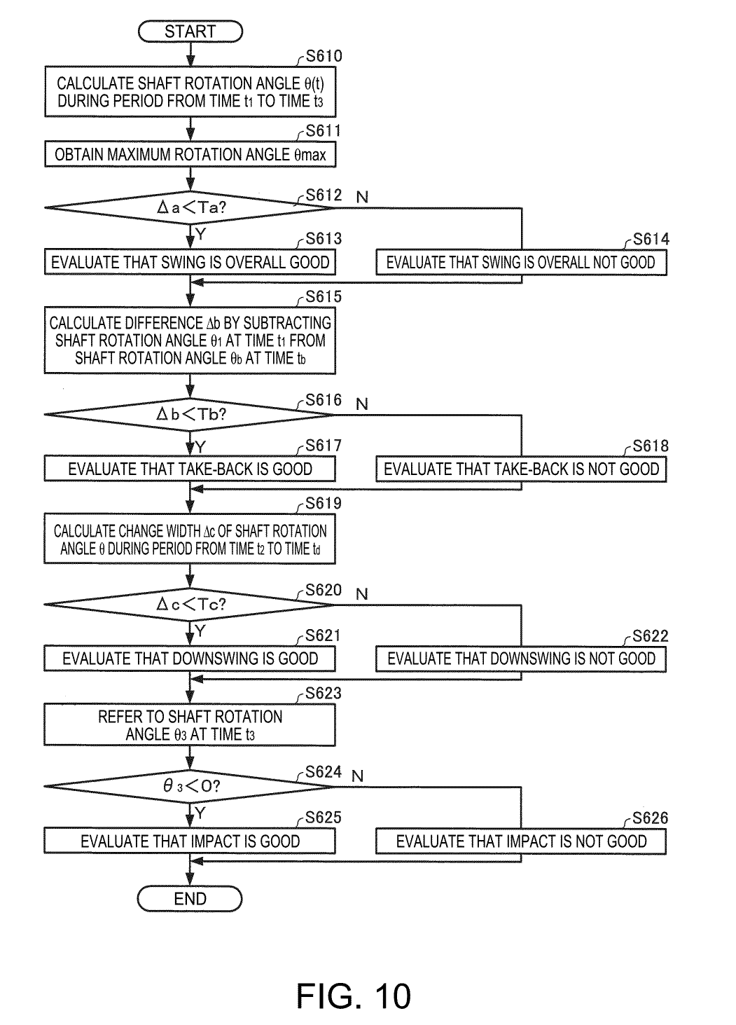

FIG. 10 is a flowchart illustrating an example of the procedure of a swing evaluation process (step S60 of FIG. 6). The swing evaluation process mainly corresponds to an operation of the processor 21 serving as of the angle detector 214 and the evaluator 215. Hereinafter, the flowchart of FIG. 10 will be described.

First, the processor 21 calculates a shaft rotation angle θ(t) at each time t during a predetermined period (time t₁ to time t₃) from measurement time t₁ of swing start to measurement time t₃ of impact (S610).

The shaft rotation angle θ(t) at time t is a rotation angle around the central axis of the shaft of the golf club 3 at time t and is assumed here to be indicated using a rotation angle at time t₁ as a criterion. Accordingly, for example, the shaft rotation angle θ(t) can be obtained, for example, by performing time integration on the angular velocity data around the y axis generated by the sensor unit 10 over a section from time t₁ to time t. When the golf club 3 is a right-handed golf club, the processor 21 sets a right rotation direction when viewed from the user 2 holding the golf club 3 as a +θ direction. When the golf club 3 is a left-handed golf club, the processor 21 sets a left rotation direction when viewed from the user 2 holding the golf club 3 as a +θ direction. For example, based on the club specification information 242, the processor 21 determines whether the golf club 3 is a right-handed golf club or a left-handed golf club.

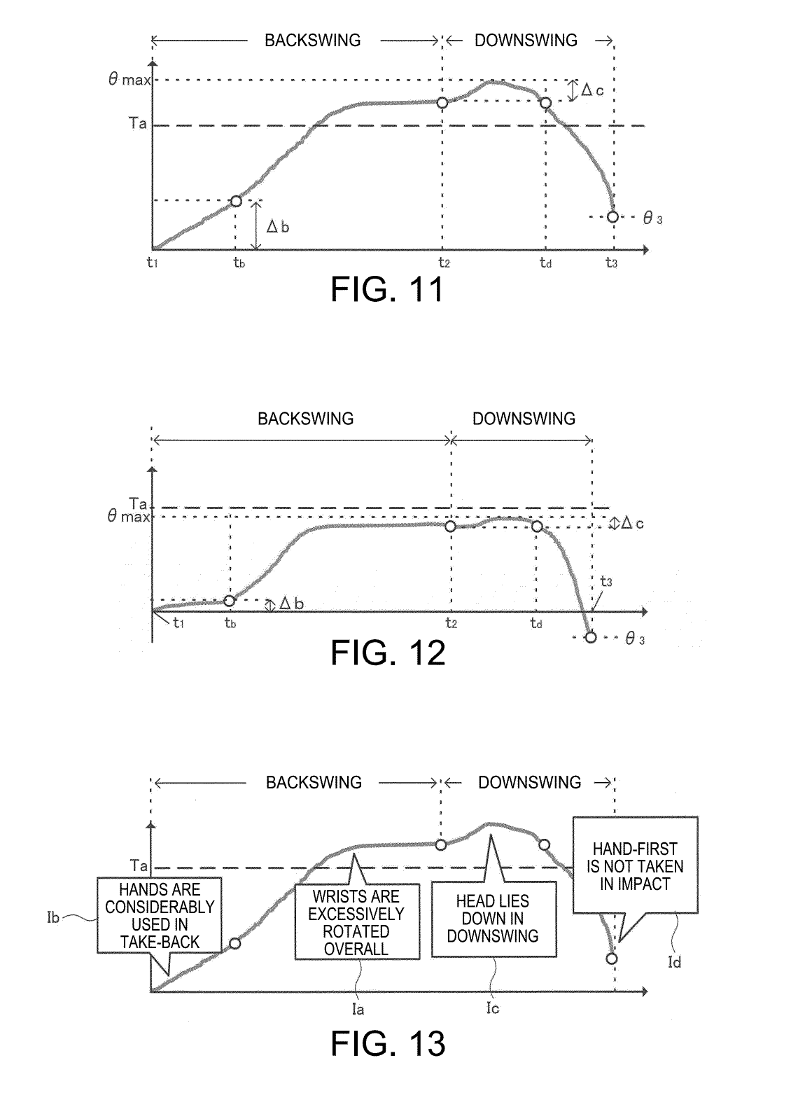

Here, an example of a temporal change curve of the shaft rotation angle θ is illustrated in FIG. 11. As described above, since the criterion of the shaft rotation angle θ(t) is a shaft rotation angle θ(t=t₁) at time t₁, the value of the shaft rotation angle θ=t₁) at time t₁ is zero. The shaft rotation angle θ(t) tends to increase during a period of a backswing (time t₁ to time t₂) and tends to decrease during a period of downswing (time t₂ to time t₃).

Next, the processor 21 obtains a maximum value (maximum rotation angle θₘₐₓ) of the shaft rotation angle θ during a predetermined period (time t₁ to time t₃) as an index for roughly evaluating the entire swing (S611).

Here, an example of a temporal change curve of the shaft rotation angle θ for a golf beginner is illustrated in FIG. 11 and an example of a temporal change curve of the shaft rotation angle θ for an advanced golfer (for example, a professional golfer) is illustrated in FIG. 12. As apparent from comparison between FIGS. 11 and 12, the maximum shaft rotation angle θₘₐₓ tends to be smaller for an advanced golfer than a golf beginner. This is because that a golf beginner tends to rotate his or her wrists excessively because the golf beginner cannot control the weight of a head whereas an advanced golfer can stabilize his or her wrists against the weight of a head. Incidentally, even the maximum shaft rotation angle θₘₐₓ of a professional golfer is merely about 50 degrees at most.

Next, the processor 21 determines whether the maximum shaft rotation angle θₘₐₓ falls less than an ideal upper limit Ta decided in advance (S612). When the maximum shaft rotation angle θₘₐₓ falls less than the ideal upper limit Ta, the processor 21 acquires an evaluation result indicating that the swing of the user 2 is overall good (the wrist rotation amount is appropriate) (S613). When the maximum shaft rotation angle θₘₐₓ does not fall less than the ideal upper limit Ta, the processor 21 acquires an evaluation result indicating the swing of the user 2 is overall not good (the wrist rotation amount is excessive) (S614). The value of the ideal upper limit Ta is, for example, set to substantially the same as the maximum rotation angle (50 degrees) of various professional golfers.

Next, the processor 21 calculates a difference Δb which is an index for evaluating take-back by subtracting the shaft rotation angle θ(t=t₁) at measurement time t₁ of the swing start from the shaft rotation angle θ(t=t_{b}) at measurement time t_{b} of the take-back (S615).

Here, as apparent from comparison between FIGS. 11 and 12, the difference Δb tends to be smaller for an advanced golfer than a golf beginner. This is because an advanced golfer can take back using rotation of the body without dependency on the rotation of his or her wrist whereas a golf beginner takes back with dependency on rotation of his or her wrist.

Next, the processor 21 determines whether the difference Δb falls less than a predetermined threshold value Tb (S616). When the difference Δb falls less than the predetermined threshold value Tb, the processor 21 acquires an evaluation result indicating that a take-back motion of the user 2 is overall good (the wrist rotation amount is appropriate) (S617). When the difference 4b does not fall less than the predetermined threshold value Tb, the processor 21 acquires an evaluation result indicating the take-back motion of the user 2 is overall not good (the wrist rotation amount is excessive) (S618).

Next, the processor 21 calculates a change width Δc of the shaft rotation angle θ(t) during a period (t₂ to t_{d}) from measurement time t₂ of the top to measurement time t_{d} of the halfway-down as an evaluation index of a downswing (S619). The change width Δc can be obtained, for example, by subtracting the minimum shaft rotation angle at the period (t₂ to t_{d}) from the maximum shaft rotation angle during the period (t₂ to t_{d}).

Here, as apparent from comparison between FIGS. 11 and 12, the change width Δc tends to be smaller for an advanced golfer than a golf beginner. This is because a head tends to lie down in the downswing for a golf beginner, whereas a head tends to stand in the downswing for an advanced golfer.

Next, the processor 21 determines whether the change width Δc falls less than a threshold value Tc (S620). When the change width Δc falls less than the threshold value Tc, an evaluation result indicating that the downswing of the user 2 is good (the head stands) is acquired (S621). When the change width Δc does not fall less than the threshold value Tc, an evaluation result indicating the downswing of the user 2 is not good (the head lies down) is acquired (S622).

Next, the processor 21 refers a shaft rotation angle θ₃ at measurement time t₃ of the impact as an evaluation index of an impact posture (S623).

Here, as apparent from comparison between FIGS. 11 and 12, the shaft rotation angle θ₃ is a positive value in many cases for a golf beginner, whereas the shaft rotation angle θ₃ is almost certainly a negative value for an advanced golfer. This is because a golf beginner may not take a hand-first posture (a posture at which the position of a hand is closer to a target side than a head) in many cases at the time of the impact, whereas an advance golfer can take the hand-first posture at the time of the impact substantially reliably.

Next, the processor 21 determines whether the shaft rotation angle θ₃ falls less than zero (S624). When the shaft rotation angle θ₃ falls less than zero, the processor 21 acquires an evaluation result indicating that the impact posture of the user 2 is good (the user takes the hand-first posture) (S625). When the shaft rotation angle θ₃ does not fall less than zero, the processor 21 acquires an evaluation result indicating that the impact posture of the user 2 is not good (the user does not take the hand-first posture) (S626), and then the process ends.

In the flowchart of FIG. 10, the sequence of the steps may be appropriately changed within a possible range.

### Process of Displaying Evaluation Result

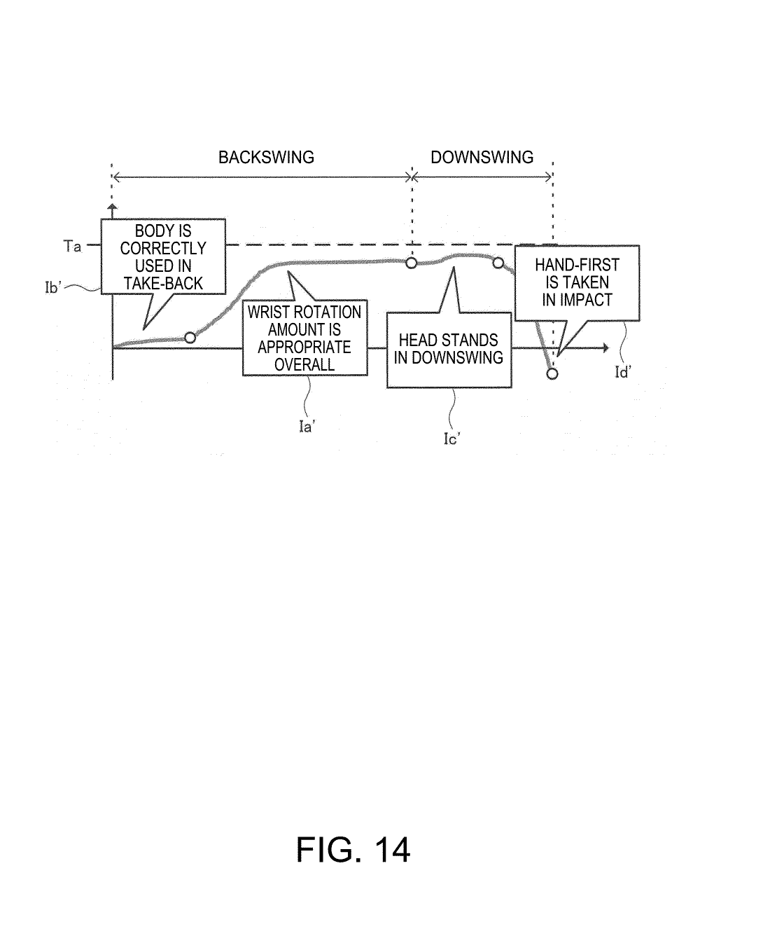

FIGS. 13 and 14 are diagrams illustrating examples of evaluation result display processes. The display process mainly corresponds to an operation of the processor 21 serving as the display processor 217.

The processor 21 generates images indicating the result of the evaluation process (FIG. 10) and displays the generated images on the displayer 25, for example, as illustrated in FIGS. 13 and 14.

An example of the image displayed, for example, when the user 2 is a golf beginner and the negative evaluation result (steps S614, S618, S622, and S626) are obtained in all of the evaluations is illustrated in FIG. 13. An example of the image displayed, for example, when the user 2 is an advanced golfer and the positive evaluation result (steps S613, S617, S621, and S625) are obtained in all of the evaluations is illustrated in FIG. 14.

The image illustrated in FIG. 13 is an image in which messages Ia to Id are displayed along with an image of a graph indicating a temporal change curve of the shaft rotation angle θ. An ideal upper limit of the shaft rotation angle θ is indicated by reference sign Ta in FIG. 13.

The message Ia is a message indicating that a swing motion is overall not good (the wrist rotation amount is excessive). The message Ia is displayed, for example, near a straight line indicating the ideal upper limit Ta.

The message Ib is a message indicating that a take-back motion is not good (the wrist rotation amount is excessive). The message Ib is displayed, for example, in a portion corresponding to the take-back in the temporal change curve of the shaft rotation angle θ.

The message Ic is a message indicating that a downswing is not good (the head lies down). The message Ic is displayed, for example, in a portion corresponding to the downswing in the temporal change curve of the shaft rotation angle θ.

The message Id is a message indicating that an impact posture is not good (a hand-first posture is not taken). The message Id is displayed, for example, in a portion corresponding to the impact in the temporal change curve of the shaft rotation angle θ.

The image illustrated in FIG. 14 is an image in which messages Ia′ to Id′ are displayed along with an image of a graph indicating a temporal change curve of the shaft rotation angle θ. An ideal upper limit of the shaft rotation angle θ is indicated by reference sign Ta in FIG. 14.

The message Ia′ is a message indicating that a swing motion is overall good (the wrist rotation amount is appropriate). The message Ia′ is displayed, for example, near a straight line indicating the ideal upper limit Ta.

The message Ib′ is a message indicating that a take-back motion is good (the wrist rotation amount is appropriate). The message Ib′ is displayed, for example, in a portion corresponding to the take-back in the temporal change curve of the shaft rotation angle θ.

The message Ic′ is a message indicating that a downswing is good (the head stands). The message Ic′ is displayed, for example, in a portion corresponding to the downswing in the temporal change curve of the shaft rotation angle θ.

The message Id′ is a message indicating that an impact posture is good (a hand-first posture is taken). The message Id′ is displayed, for example, in a portion corresponding to the impact in the temporal change curve of the shaft rotation angle θ.

### 1-4. Advantages

As described above, the processor 21 according to the embodiment performs the processes of detecting the shaft rotation angle θ using an output of the inertial sensor and evaluating a swing based on a change (temporal change) in the shaft rotation angle θ.

The shaft rotation angle θ is an amount which can be simply acquired by the inertial sensor such as an angular velocity sensor, but an exercise of a wrist which is one of the important motions in a swing is considered to be strongly reflected to the temporal change in the shaft rotation angle θ.

Accordingly, the processor 21 according to the embodiment can evaluate a swing of the user simply and objectively.

The processor 21 according to the embodiment evaluates a swing at each of the several checkpoints. Specifically, for example, the processor 21 evaluates a swing at each of take-back, a downswing, and impact.

The processor 21 according to the embodiment can evaluate a swing of the user in detail.

### 2. Modification Examples

The invention is not limited to the embodiment, but may be modified variously within the scope of the gist of the invention.

For example, in the foregoing embodiment, the hand-first posture at the impact has been evaluated as the posture of a swing of the user handling the golf club (which is an example of an exercise tool). However, another posture may be evaluated at a different timing. For example, a hand-first posture at address may be evaluated in the same manner as the hand-first posture at the impact.

The processor 21 according to the foregoing embodiment mainly adopts the image as the announcement form of the evaluation result. For example, another announcement form such as a temporal change pattern of light intensity, a temporal change pattern of color, a change pattern of audio intensity, a change pattern of an audio frequency, or a rhythm pattern of vibration may be adopted.

In the foregoing embodiment, some or all of the functions of the processor 21 may be mounted on the side of the sensor unit 10. Some of the functions of the sensor unit 10 may be mounted on the side of the processor 21.

In the foregoing embodiment, some or all of the processes of the processor 21 may be performed by an external device (a tablet PC, a laptop PC, a desktop PC, a smartphone, or a network server) of the swing analysis device 20.

In the foregoing embodiment, some or all of the acquired data may be transferred (uploaded) to an external device such as a network server by the swing analysis device 20. The user may browse or download the uploaded data on or to the swing analysis device 20 or an external device (a personal computer, a smartphone, or the like) as necessary.

The swing analysis device 20 may be another portable information device such as a head-mounted display (HMD) or a smartphone.

In the foregoing embodiment, the sensor unit 10 is mounted on the grip of the golf club 3, but may be mounted on another portion of the golf club 3.

In the foregoing embodiment, each motion is detected in a swing of the user 2 using a square root of a sum of the squares expressed in formula (1) as the composite value of the triaxial angular velocities measured by the sensor unit 10. However, besides the composite value of triaxial angular velocities, for example, a sum of the squares of the triaxial angular velocities, a sum or an average value of the triaxial angular velocities, or a product of the triaxial angular velocities may be used as the composite value of the triaxial angular velocities. Instead of the composite value of the triaxial angular velocities, a composite value of triaxial accelerations, such as a sum of squares of the triaxial angular velocities, a square root of the sum of the squares of the triaxial angular velocities, a sum or an average value of the triaxial angular velocities, or a product of the triaxial angular velocities may be used.

In the foregoing embodiment, the acceleration sensor 12 and the angular velocity sensor 14 are built to be integrated in the sensor unit 10. However, the acceleration sensor 12 and the angular velocity sensor 14 may not be integrated. Alternatively, the acceleration sensor 12 and the angular velocity sensor 14 may not be built in the sensor unit 10, but may be directly mounted on the golf club 3 or the user 2. In the foregoing embodiment, the sensor unit 10 and the swing analysis device 20 are separated from each other. The sensor unit 10 and the swing analysis device 20 may be integrated to be mounted on the golf club 3 or the user 2.

In the foregoing embodiment, the swing analysis system that analyzes a golf swing has been described as an example. However, the invention can be applied to a swing analysis system (swing analysis device) analyzing swings of various exercises such as tennis, baseball, and the like.

The foregoing embodiments and modification examples are merely examples, but the invention is not limited thereto. For example, the embodiments and the modification examples can also be appropriately combined.

The invention includes configurations (for example, configurations in which functions, methods, and results are the same or configurations in which objects and advantages are the same) which are substantially the same as the configurations described in the embodiments. The invention includes configurations in which non-essential portions of the configurations described in the embodiments are substituted. The invention includes configurations in which the same operational advantages as the configurations described in the embodiments are obtained or configurations in which the same objects can be achieved. The invention includes configurations in which known technologies are added to the configurations described in the embodiments.

The entire disclosure of Japanese Patent Application No. 2014-258535, filed Dec. 22, 2014 is expressly incorporated by reference herein.

What is claimed is:

1. An exercise analysis device comprising:
an angle detector that obtains a change in a rotation angle occurring around an axis of a shaft portion of an exercise tool in a swing by using an output of an inertial sensor; and
an evaluator that performs at least partial evaluation from start to end of the swing based on the change in the rotation angle.

2. The exercise analysis device according to claim 1,
wherein the evaluator evaluates take-back based on the change in the rotation angle during a period from the start of the swing to halfway-back.

3. The exercise analysis device according to claim 1,
wherein the evaluator evaluates a downswing based on the change in the rotation angle during a period from top to halfway-down.

4. The exercise analysis device according to claim 1,
wherein the evaluator evaluates a posture of a user handling the exercise tool based on a difference between the rotation angle at the start of the swing and the rotation angle at impact.

5. The exercise analysis device according to claim 3,
wherein the evaluator evaluates a posture of a user handling the exercise tool based on a difference between the rotation angle at the start of the swing and the rotation angle at impact.

6. An exercise analysis system comprising:
the exercise analysis device according to claim 1; and
an inertial sensor.

7. An exercise analysis system comprising:
the exercise analysis device according to claim 2; and
an inertial sensor.

8. An exercise analysis system comprising:
the exercise analysis device according to claim 3; and
an inertial sensor.

9. An exercise analysis system comprising:
the exercise analysis device according to claim 4; and
an inertial sensor.

10. An exercise analysis method comprising:
obtaining a change in a rotation angle occurring around an axis of a shaft portion of an exercise tool in a swing by using an output of an inertial sensor; and
performing at least partial evaluation from start to end of the swing based on the change in the rotation angle.

11. The exercise analysis method according to claim 10,
wherein in evaluating, take-back is evaluated based on the change in the rotation angle during a period from the start of the swing to halfway-back.

12. The exercise analysis method according to claim 10,
wherein in evaluating, a downswing is evaluated based on the change in the rotation angle during a period from top to halfway-down.

13. The exercise analysis method according to claim 10,
wherein in evaluating, a posture of a user handling the exercise tool is evaluated based on a difference between the rotation angle at the start of the swing and the rotation angle at impact.

14. The exercise analysis method according to claim 12,
wherein in evaluating, a posture of a user handling the exercise tool is evaluated based on a difference between the rotation angle at the start of the swing and the rotation angle at impact.

15. A display device displaying, using an output of an inertial sensor,
a change in a rotation angle occurring around an axis of a shaft portion of an exercise tool in a swing; and
at least partial evaluation from start to end of the swing based on the change in the rotation angle.

16. A recording medium that records an exercise analysis program causing a computer to perform:
obtaining a change in a rotation angle occurring around an axis of a shaft portion of an exercise tool in a swing by using an output of an inertial sensor; and
performing at least partial evaluation from start to end of the swing based on the change in the rotation angle.
